(19) United States
(12) Patent Application Publication
(10) Pub. No.: US 2025/0236351 A1
(43) Pub. Date: Jul. 24, 2025

(54) Portable Housing Structure

(71) Applicant: Jeremy D. Hill, East Bethel, MN (US)

(72) Inventor: Jeremy D. Hill, East Bethel, MN (US)

(21) Appl. No.: 19/032,869

(22) Filed: Jan. 21, 2025

Related U.S. Application Data
(60) Provisional application No. 63/622,283, filed on Jan. 18, 2024.

(51) Int. Cl. B62D 63/06; B60D 1/01; B60P 3/32; B60R 13/08; B60R 16/03; B62D 27/06; B62D 63/08

(52) U.S. Cl. CPC B62D 63/061; B60P 3/32; B60R 13/0815; B62D 27/06; B62D 63/08; B60D 1/01; B60R 16/03

(57) ABSTRACT

Present examples provide an apparatus, comprising: a platform, an enclosed structure that is connected to the platform in a first mode and separated from the platform in a second mode, the enclosed structure comprising: a first shell coupled to the platform to define an interior of an enclosed area, a second shell coupled to the first shell to increase a rigidity of the first shell when coupled to the first shell, and a third shell coupled to the second shell to protect the first shell and the second shell from external elements.

### TECHNICAL FIELD

Embodiments of the disclosure relate to portable housing structures and modular trailers that can be used as a flatbed trailer, covered trailer, camper, fish house, hunting blind, or other functions.

### BACKGROUND

Outdoor activities can be performed utilizing enclosed structures to protect users from the environment. For example, humans can do outdoor activities such as hunting, ice fishing, bird watching, and/or other activities where the user may utilize an enclosed structure to protect themselves from the weather or other outdoor elements. These enclosed structures can be relatively heavy and may require a separate motor vehicle or other type of transportation system to move the enclosed structure to the location of the outdoor activity. For example, an icehouse can be relatively heavy and require a user to pull the ice house with a motor vehicle.

In addition to the enclosed structures, human users may want to utilize other types of equipment, devices, personal motor vehicles during the outdoor activities. This additional equipment for outdoor activities can also be relatively heavy and require a trailer or other type of device to move the devices to the location of the outdoor activities. For this reason, people who partake in multiple different outdoor activities can be required to own multiple different devices or towing mechanisms to transport and store the enclosed structures and/or equipment for their outdoor activities.

### BRIEF DESCRIPTION OF THE DRAWINGS

The disclosure will be understood more fully from the detailed description given below and from the accompanying drawings of various embodiments of the disclosure.

FIG. 1 illustrates a system for a portable housing structure according to aspects of the present disclosure.

FIG. 2 illustrates an enclosed structure of a system for a portable housing structure according to aspects of the present disclosure.

FIG. 3 illustrates a platform portion of a system for a portable housing structure according to aspects of the present disclosure.

FIG. 4 illustrates a system for a portable housing structure according to aspects of the present disclosure.

FIG. 5 illustrates a system for a portable housing structure according to aspects of the present disclosure.

FIG. 6 illustrates the bottom side of an enclosed structure of a system for a portable housing structure according to aspects of the present disclosure.

FIG. 7 illustrates a platform portion of a system for a portable housing structure according to aspects of the present disclosure.

FIG. 8 illustrates the bottom side of a system for a portable housing structure according to aspects of the present disclosure.

FIG. 9 illustrates a locking mechanism for a system for a portable housing structure according to aspects of the present disclosure.

FIG. 10 illustrates a platform portion of a system for a portable housing structure according to aspects of the present disclosure.

FIG. 11 illustrates a platform portion of a system for a portable housing structure according to aspects of the present disclosure.

FIG. 12 illustrates an enclosed structure of a system for a portable housing structure with a plurality of nesting shells according to aspects of the present disclosure.

FIG. 13 illustrates an intermediate nesting shell of a plurality of nesting shells from an enclosed structure according to aspects of the present disclosure.

FIG. 14 illustrates an interior nesting shell of a plurality of nesting shells from enclosed structure according to aspects of the present disclosure.

### SUMMARY OF THE INVENTION

In some aspects, the techniques described herein relate to an apparatus, including: a platform; an enclosed structure that is connected to the platform in a first mode and separated from the platform in a second mode, the enclosed structure including: a first shell to define an interior of an enclosed area; a second shell coupled to the first shell to increase a rigidity of the first shell when coupled to the first shell; a third shell coupled to the second shell to protect the first shell and the second shell from external elements; and a; a mechanism to couple the enclosed structure to the platform.

In some aspects, the techniques described herein relate to an apparatus, wherein the second shell includes a ribbed surface with pockets formed to facilitate additional structural components, wherein the additional structural components include one or more of insulation, electrical components, and hardware components. In some aspects, the techniques described herein relate to an apparatus, wherein the second shell includes a toboggan shaped structure that nests within the third shell with a toboggan shaped structure.

In some aspects, the techniques described herein relate to an apparatus, wherein the third shell includes a plurality of keels formed into a bottom surface of the third shell and wherein the keels include keel covers. In some aspects, the techniques described herein relate to an apparatus, including support beams and electrical wiring positioned between a ribbed surface of the second shell and a surface of the third shell.

In some aspects, the techniques described herein relate to an apparatus, wherein the first shell, the second shell, and the third shell are separate pieces that are manufactured separately. In some aspects, the techniques described herein relate to an apparatus, wherein the second shell includes a ribbed surface that creates voids between the second shell and the third shell and wherein the voids are filled with a spray insulation material.

In some aspects, the techniques described herein relate to a trailer assembly, including: a removable enclosed structure including a plurality of nesting shells; interior components coupled to an interior portion of a first shell of the plurality of nesting shells; paneling coupled between at least one of the interior components of the first shell and a second shell of the plurality of nesting shells; access panels through the first shell and the second shell to allow access to a third shell; and quick attachment devices positioned at a plurality of locations of the interior portion of the first shell to couple accessories to the interior portion of the first shell, wherein the plurality of nesting shells are manufactured independently.

In some aspects, the techniques described herein relate to a trailer assembly, including ground access panels through the third shell to access an exterior portion of the removable enclosed structure, wherein the ground access panels include internally threaded collars. In some aspects, the techniques described herein relate to a trailer assembly, wherein the quick attachment devices include a base that allows protruding fins of an attachment to be locked within the quick attachment devices.

In some aspects, the techniques described herein relate to a trailer assembly, wherein the quick attachment devices include an integrated tie-down connection. In some aspects, the techniques described herein relate to a trailer assembly, including towing hooks coupled to an exterior portion of the third shell. In some aspects, the techniques described herein relate to a trailer assembly, including a set of double doors at a first end of the first shell, the second shell, and the third shell to allow the trailer assembly to be utilized as a covered trailer.

In some aspects, the techniques described herein relate to a trailer assembly, wherein the removable enclosed structure includes a cam lock device to couple the removeable enclosed structure to a platform structure from the interior portion of the first shell. In some aspects, the techniques described herein relate to a trailer assembly, including a platform structure that includes a hitch and an axle to allow the platform structure to be pulled as a trailer, wherein the platform structure includes a cam lock device to lock the removable enclosed structure to a surface of the platform structure.

In some aspects, the techniques described herein relate to a trailer assembly, wherein the platform structure includes a locking track system of recesses (e.g., locking track system of recesses, etc.) to allow keels coupled to the third shell (e.g., formed into the third shell, etc.) to be positioned within the locking track system. In some aspects, the techniques described herein relate to a system, including: a removable enclosed structure including a plurality of nesting shells that allow components to be positioned between the plurality of nesting shells, wherein one of the plurality of shells includes a cam lock device; a platform structure including an axle, a hitch, and a flatbed, wherein the platform structure includes: a locking track system that includes a plurality of recesses (e.g., grooves, slots, etc.) within the flatbed to receive keels coupled to the removable enclosed structure, wherein the cam lock device includes a locking tab that rotates to lock the removable enclosed structure utilizing the keels; a plurality of adjustable tie downs moveable along a sliding mechanism coupled to an edge of the flatbed; a winch device to move the removable enclosed structure from a first end of flatbed to a second end of the flatbed; and a chassis positioning system to adjust a height of the flatbed.

In some aspects, the techniques described herein relate to a system, wherein the chassis positioning system includes independent chassis (e.g., independent axles, etc.) for each wheel of the platform structure such that an axle does not extend below the flatbed. In some aspects, the techniques described herein relate to a system, wherein the chassis positioning system is a pivoting drop wheel assembly with a jack device fixed adjacent to the chassis positioning system. In some aspects, the techniques described herein relate to a system, including a split portion of the flatbed coupled by a hinge to allow the split portion to rotate around the hinge, wherein the split portion rotates to meet a surface of an exterior shell of the plurality of shells.

In some embodiments, The combination of features present on both the enclosed structure and the platform allow the modular trailer to perform multiple novel and useful functions that otherwise could not be performed by a regular trailer or otherwise similar structure. While each structure is needed to make the overall modular trailer assembly, the enclosed structure can be removed from the platform such that either structure can be used independently from each other. The ability to separate each structure from the other further allows the modular trailer to perform novel and useful functions that otherwise could not be performed by a regular trailer or otherwise similar structure.

### DETAILED DESCRIPTION

Currently a wide variety of motor vehicle haulers (e.g., trailers, etc.) and a wide variety of enclosures (e.g., ice houses, hunting blinds, etc.) can be used for various outdoor activities. The current trailers and/or enclosures can be designed for a particular purpose. For example, trailers can be designed to haul particular items. For example, a flatbed trailer can be designed to haul equipment without an integrated canopy, a covered trailer can be designed to haul equipment within an enclosure, tilt trailers can have a tilting bed to enable equipment to be loaded more easily, among other types of trailers. In these examples, a first type of trailer may work great for a particular purpose, but not work for a different purpose. For this reason, a user may have to own multiple types of trailers to perform a plurality of different functions.

Some existing enclosures, such as fish houses and hunting blinds, can utilize an integrated trailer or system for moving the enclosure from one location to another using a motorized vehicle. For example, a fish house can include an axil and a hitch to allow the fish house to be connected to a motorized vehicle and moved from a storage location to a location on a frozen lake. Although the fish house with an integrated trailer may work well for moving the fish house from a first location to a second location, the fish house may not be useable for other purposes. For example, the fish house may not work well as a covered trailer and the integrated trailer may not work at all as a flatbed trailer. Although examples of a fish house or hunting blind are utilized to describe specific examples, the present disclosure is not so limited. For example, the enclosure described herein, and the platform described herein can be utilized for a plurality of additional activities that utilize one or more of a flatbed trailer, an enclosed trailer, and/or an enclosure. For example, many trailers include features that substantially increase the weight of the trailer so that it is only usable in certain circumstances. Other trailers include features that substantially increase the complexity of the overall assembly, making the trailer difficult and expensive to manufacture and maintain.

Finally, because of the specialization of these trailers, those who would like to own and use these trailers often must buy, store, and maintain several different trailers at once. For example, a person who is interested in ice fishing is often also interested in hunting or camping, and may also often use utility trailers, requiring this person to own an enclosed trailer, a flatbed trailer, an ice fishing trailer, a camper, and more. Due to the time and costs associated with owning several different trailers, a person must either have a large space for which to store their different trailers, or they must pick and choose which kinds of trailers they would like to purchase.

Altogether, no single trailer exists which can perform the functions of multiple different types of specialized trailers without sacrificing in another area. Some trailers are successful in mitigating the trade-offs inherent in certain features but otherwise are unsuccessful in creating a trailer which can embody multiple different functions in one unit.

In response to these shortcomings, the present disclosure describes a system for a modular trailer which is successful in combining the functionality of multiple different types of trailers while substantially mitigating any potential downsides of such a design and instead uses the combination of said features to augment the overall functionality of the trailer beyond the functionality of each individual feature, thereby creating a modular trailer that is greater than the sum of its parts.

For example, the enclosed structure can include a plurality of nesting shells. The plurality of nesting shells can include one or more integrally formed features which facilitate the placement and installation of additional features and components. The three shells (e.g., interior shell, intermediate shell, exterior shell, etc.) allow the enclosed structure to be extremely lightweight relative to most other trailers, while also providing substantial strength and insulation from the elements.

In any embodiment, the nested shells would be fastened to each other using rivets, screws, adhesive, or any other fastening method. In the preferred embodiment, the Enclosed Structure is split, creating a top and bottom portion of the structure, where each portion consists of three nesting shells: an exterior shell, a middle shell, and an interior shell. In some embodiments, the enclosed structure may be split at a height such that the bottom half of the structure may have relatively tall walls. In this embodiment, the tall walls of the bottom half of the structure may allow the enclosed structure to float in water. In any embodiment, the shells of each half would be fastened to each other, and then the two assembled halves would be fastened to each other, creating a fully enclosed structure.

The plurality of nesting shells that make up the enclosed structure would be formed/molded through a thermoforming, roto molding (rotational molding), or similar process, and may have additional cutting, trimming, and shaping processes applied to them after forming/molding. These processes allow for quick and inexpensive manufacturing of each shell and allow the use of lightweight and strong plastics to makeup the overall body of the enclosed structure. The exterior and interior shells may be formed from a thinner material to reduce weight, while the intermediate shell may be formed from a thicker material for additional strength. When the three shells are assembled, they grant the enclosed structure strength and rigidity that is substantially superior to similarly formed or molded structures, while being of a substantially lower weight.

Because the enclosed structure described herein is removable from the platform, a person could have multiple enclosed structures, where each is configured for different use cases. For example, a person could have a first enclosed structure, which is used as a shed for their ice fishing equipment, and have a second enclosed structure, which is used for hunting. Most of the year, the ice fishing enclosed structure is used as a storage shed, but in the winter, it could be used for ice fishing, by swapping the hunting enclosed structure out for their ice fishing enclosed structure.

Similarly, if a person only owned one enclosed structure, they could configure the enclosed structure for a specific activity like ice fishing. During most of the year, the enclosed structure is being used as a storage shed, while the platform is being used as a general utility trailer. When they decide to go ice fishing, the person only must load the enclosed structure on the platform, and they are ready to go.

In another case, there may be a business that provides an ice fishing chartering service. This business could own several Enclosed Structures, all of which are configured for ice fishing, while only needed to own one or a few Platform Structures, allowing the business to place their enclosures around a lake with minimal effort and maintenance.

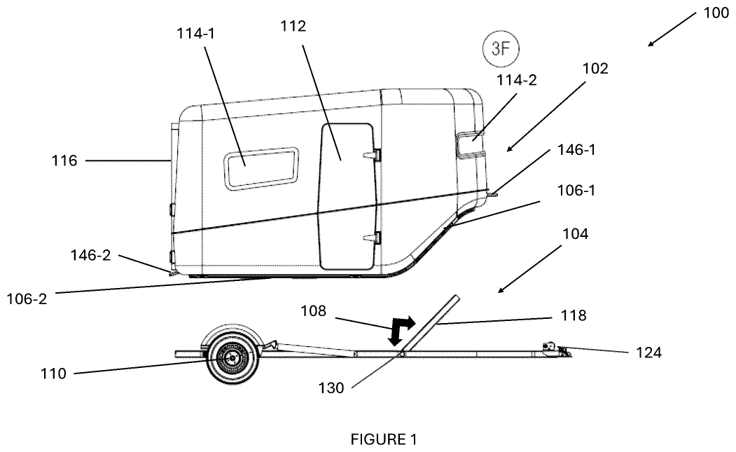

FIG. 1 illustrates a system 100 for a portable housing structure according to aspects of the present disclosure. The system 100 is one example of the portable housing structure that includes an enclosed structure 102 and a platform 104. As illustrated in FIG. 1, the enclosed structure 102 can be removable from the platform 104. For example, the enclosed structure 102 can be connected to the platform 104 in a first mode (e.g., locked mode, connected mode, etc.) and separated from the platform 104 in a second mode (e.g., unlocked mode, disconnected mode, etc.).

As described further herein, the enclosed structure 102 can be a structure that includes a plurality of nesting shells that allow components to be positioned between the plurality of nesting shells. For example, electrical, plumbing, insulation, or other materials can be positioned between one or more of a first shell coupled to the platform to define an interior of an enclosed area, a second shell coupled to the first shell to increase a rigidity of the first shell when coupled to the first shell, and a third shell coupled to the second shell to protect the first shell and the second shell from external elements.

In some embodiments, the platform 104 can have similar components to a flatbed trailer. For example, the platform 104 can include a hitch 124 that can be utilized to connect the platform 104 to a motorized vehicle. As used herein, a hitch 124 can refer to trailer hitch that can be connected to a towing mechanism of a motor vehicle. In a specific embodiment, the hitch 124 can include a ball mount hitch, pintle hitch, gooseneck hitch, or other similar devices for ensuring that the platform 104 is connected to a motorized vehicle securely during transportation of the platform 104 and/or the platform 104 with the enclosed structure 102 connected to the platform 104.

In some embodiments, the platform 104 can include a chassis 110. The chassis 110 can include a system of components for enabling a wheel to move the platform 104 when a force is applied to the hitch 124. For example, the chassis 110 can include a suspension system (e.g., leaf springs, shocks, etc.), brakes (e.g., electric brakes, pneumatic brakes, etc.), fenders, and/or an axle for coupling a wheel to the chassis 110. As described further herein, the chassis 110 can be independent on each side of the platform 104 such that the chassis 110 on a first side is not connected to the chassis 110 on a second side of the platform 104 by an axle or other coupling device. In some embodiments, independent axles or chassis for each wheel of the platform 104 structure such that an axle does not extend below the bed 108 of the platform 104. As described further herein, the independent chassis 110 can enable the platform 104 to be raised and lowered completely to the ground such that a bottom surface of the 104 can be in contact with the ground when the independent chassis 110 is completely raised (e.g., wheels of the chassis 110 rotated up to lower the platform 104).

In some embodiments, the platform 104 can include a split portion 118. The split portion 118 can be coupled to a main portion of the platform 104 by a hinge 130. In this way, the hinge 130 can allow the split portion 118 to be positioned at a plurality of different angles relative to the bed 108 of the platform 104. As used herein, the bed 108 can refer to a portion of the platform 104 utilized to haul equipment, items, and/or the enclosed structure 102. That is, the bed 108 can be a loading area of a trailer that can support the items to be carried utilizing the chassis 110 and/or the hitch 124.

In some embodiments, the enclosed structure 102 can include a first bottom portion 106-1 and a second bottom portion 106-2. The first bottom portion 106-1 can be a toboggan shaped structure that can be raised at an angle from the second bottom portion 106-2. The toboggan shaped structure can allow the enclosed structure 102 to be pulled on keels (e.g., skis, etc.) located at the first bottom portion 106-1 and/or the second bottom portion 106-2. In these embodiments, the enclosed structure 102 can include a first tow ring 146-1 and/or a second tow ring 146-2 (e.g., towing hooks, towing mechanism, etc.). In some embodiments, the enclosed structure 102 can be pulled utilizing the first tow ring 146-1 to move the enclosed structure 102 from a first location to a second location without utilizing the platform 104. For example, the first tow ring 146-1 can be connected to an off-road or all-terrain vehicle utilizing a tow rope or other device such that the enclosed structure 102 can glide on the keels positioned on the second bottom portion 106-2 and/or the first bottom portion 106-1.

As described further herein, the first tow ring 146-1 can be utilized to load the enclosed structure 102 onto the bed 108 of the platform 104 utilizing a winch or other type of pulley mechanism. In some embodiments, the second tow ring 146-2 can be utilized to unload or remove the enclosed structure 102 from the platform 104. In some embodiments, the split portion 118 can be angled to align with the first bottom portion 106-1 when the enclosed structure 102 is coupled or locked with the platform 104.

In some embodiments, the enclosed structure 102 can include a door 112. The door 112 can allow a human user to enter an interior portion of the enclosed structure 102. In some embodiments, the enclosed structure 102 can include a first aperture 114-1 and a second aperture 114-2. In some embodiments, the first aperture 114-1 and/or the second aperture 114-2 can be windows or similar apertures to allow a human user to see into the enclosed structure 102 from an exterior location and/or see out of the enclosed structure 102 from an interior location. In these embodiments, the plurality of nesting shells that form the enclosed structure 102 can each include a corresponding door 112, first aperture 114-1, and/or second aperture 114-2 to form these through the structure of the enclosed structure 102.

In some embodiments, the enclosed structure 102 can include rear doors 116 at a rear of the enclosed structure 102. The rear doors 116 in the rear portion of the enclosed structure 102 can be a set of double doors, which can be wide enough for a person to load large objects, such as, but not limited to: ATVs, snowmobiles, etc., into the enclosed structure 102. In some embodiments, the windows (e.g., first aperture 114-1, second aperture 114-2, etc.) may also be openable to allow additional airflow into the enclosed structure 102. Similar windows may be installed into the rear doors 116 and/or door 112 as well. Having multiple entry points on the enclosed structure 102 increases its overall safety by providing multiple means of exiting the enclosed structure 102 in the event of an emergency. It additionally allows a person to maintain a comfortable temperature inside of the enclosed structure 102 by controlling the airflow into the enclosed structure 102.

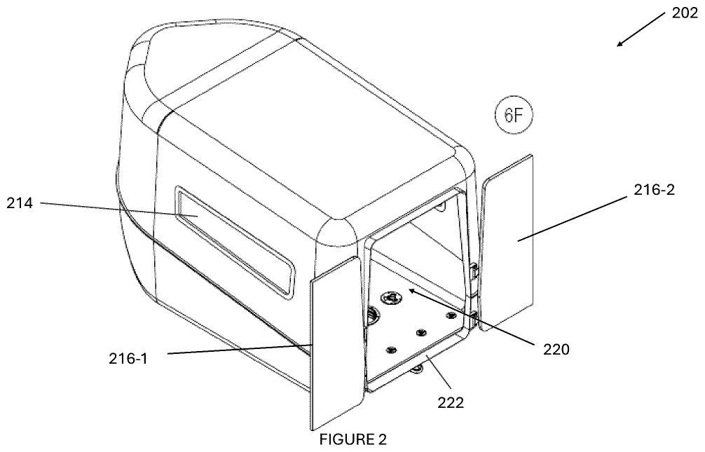

FIG. 2 illustrates an enclosed structure 202 of a system for a portable housing structure according to aspects of the present disclosure. In some embodiments, the enclosed structure 202 can include the same or similar components as the enclosed structure 102 as illustrated in FIG. 1. For example, the enclosed structure 202 can include a first rear door 216-1 and a second rear door 216-2. These types of dual rear doors 216-1, 216-2 can allow equipment to be loaded into the interior portion 220 of the enclosed structure 202.

In some embodiments, the enclosed structure 202 can be positioned on a bed of a platform (e.g., platform 104 as referenced in FIG. 1, etc.). In these embodiments, a lip 222 of the trailer can extend beyond the enclosed structure 202 to allow the lip 222 to be in contact with the ground when the platform is lowered to a ground position. In this way, the lip 222 can prevent an edge of the enclosed structure 202 from being damaged while loading equipment into the interior portion 220 of the enclosed structure 202. For example, the lip 222 can be made of wood, steel, or other sturdy material that is similar or the same as the bed of the platform. In these embodiments, the enclosed structure 202 can be made of a plurality of nesting shells that can be made of a polymer or less rigid material compared to the material of the platform.

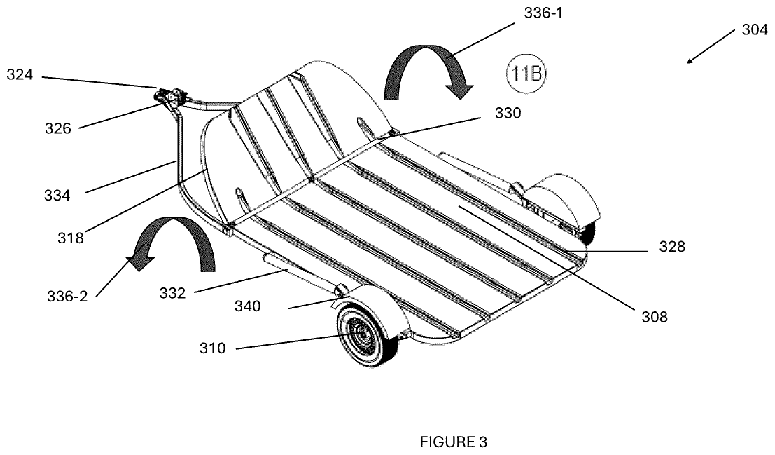

FIG. 3 illustrates a platform 304 portion of a system for a portable housing structure according to aspects of the present disclosure. The platform 304 can include the same or similar components as the platform 104 as referenced in FIG. 1. For example, the platform 304 can include a hitch 324 that can be the same or similar as the hitch 124 as referenced in FIG. 1. In a similar example, the platform 304 can include a chassis 310 (e.g., chassis 110 as referenced in FIG. 1, etc.). In some embodiments, the chassis 310 can be coupled to a fender 340. As used herein, a fender 340 can be a device that can prevent rocks from being thrown by the tires on to a surface of the platform 304 and/or the enclosed structure coupled to the bed 308 of the platform 304.

In addition, the platform 304 can include a winch 326 that is coupled to a frame 334 of the platform 304. As described further herein, the winch 326 can be a mechanical device used to pull in, let out, or adjust the tension of a rope, cable, or chain. It consists of a spool or drum around which the rope or cable is wound and is typically powered manually by a crank handle or lever, or mechanically using an electric motor, hydraulic system, or internal combustion engine.

In some embodiments, the platform 304 can include a chassis positioning system 332 (e.g., a drop wheel mechanism, pivoting drop wheel assembly, etc.) that can alter a position of the chassis 310 such that the bed 308 of the platform 304 can be lowered or raised. For example, the chassis positioning system 332 can be utilized to alter a location of the chassis 310 and/or the fender 340 to lower the bed 308 such that a bottom surface of the bed 308 can be in contact with a ground surface. In this way, the chassis positioning system 332 can be utilized to alter the height of the platform 304 from the ground to a plurality of different height levels. In some embodiments, the chassis positioning system 332 can be utilized to make it easier to load equipment on to the surface of the bed 308 and/or make it easier to load equipment into an interior portion of the enclosed structure that is coupled to the bed 308.

In addition, the chassis positioning system 332 can be utilized to adjust the running height of the platform 304 when equipment that is relatively heavy is positioned on the bed 308 of the platform 304. For example, the weight of the equipment can lower a height of the platform 304 when loaded on the bed 308. In this way, the chassis positioning system 332 can be utilized to adjust a height of the bed 308 to improve towing, which can make it safer to tow equipment loaded on the bed 308 of the platform 304.

In some embodiments, the platform 304 can include a plurality of recesses 328 (e.g., locking track system of recesses, etc.). The plurality of recesses 328 can be recessed tracks that can be utilized as a locking track system as described further herein. In some embodiments, the plurality of recesses 328 can be formed in the same or similar shape as the keels (e.g., skis, etc.) positioned on a bottom surface of the enclosed structure (e.g., enclosed structure 102, etc.). As described further herein, the plurality of recesses 328 can receive the keels of the enclosed structure to prevent side to side movement of the enclosed structure when coupled to the platform 304. In addition, the plurality of recesses 328 can include one or more locking apertures to receive a locking mechanism of the enclosed structure to prevent the enclosed structure from moving front to back (e.g., from a hitch 324 side to an opposite end or loading end, etc.) of the platform 304.

In some embodiments, the platform 304 can include a hinge 330 between a split portion 318 and the bed 308 to allow the split portion 318 to be rotated along an axis of the hinge 330. For example, the split portion 318 can be rotated in the direction of arrow 336-1 and/or arrow 336-2. In one example, the split portion 318 can be rotated in the direction of arrow 336-2 from the illustrated position in FIG. 3 to a flat position that can have the split portion 318 make contact with a portion of the frame 334 of the platform 304. In another example, the split portion 318 can be rotated in the direction of arrow 336-1 from a flat position to the illustrated position in FIG. 3. In addition, the split portion 318 may also be rotated in the direction of arrow 336-1 from the illustrated position in FIG. 3 to a backwards position. In this way, the platform 304 can be utilized as a flatbed when the split portion 318 is in the flat position and the platform 304 can be utilized as an equipment trailer (e.g., snowmobile trailer, ATV trailer, etc.) when the split portion 318 is in the raised position. In some embodiments, the split portion 318 can be utilized as a protective surface to prevent debris from damaging objects on top of the platform when the split portion 318 is in the backwards position (e.g., utility position as described further herein). As described herein, the raised position as illustrated in FIG. 3 can also be positioned at an angle that allows the split portion 318 to make contact with a bottom portion of the enclosed structure when the enclosed structure is coupled to the platform 304.

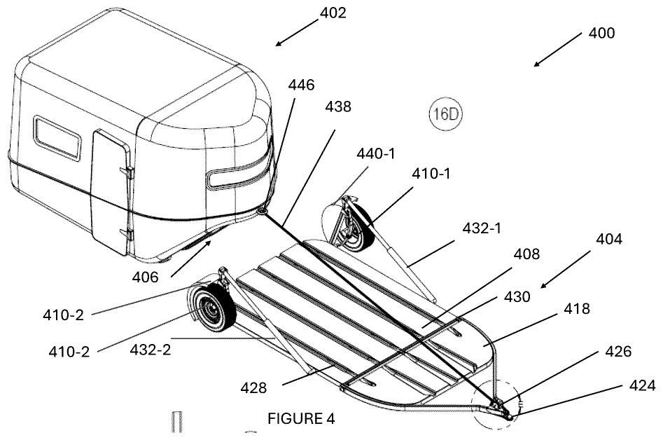

FIG. 4 illustrates a system 400 for a portable housing structure according to aspects of the present disclosure. The system 400 can include the same or similar elements as system 100 as referenced in FIG. 1. The system 400 can illustrate one example of loading the enclosed structure 402 (e.g., enclosed structure 102 as referenced in FIG. 1, etc.) onto a bed 408 of the platform 404 (e.g., platform 104 as referenced in FIG. 1, etc.). As described herein, the enclosed structure 402 can include a tow ring 446 (e.g., first tow ring 146-1 as referenced in FIG. 1, etc.). In these embodiments, the tow ring 446 can be utilized to load the enclosed structure 402 onto the bed 408 of the platform 404.

In some embodiments, the platform 404 can be lowered utilizing the chassis positioning system 432-1, 432-1 to alter a location of the chassis 410-1, 410-2 and/or fenders 440-1, 440-2 to lower the bed 408 of the platform 404 to the ground to allow the enclosed structure 402 to slide on to the bed 408 of the platform 404. In some embodiments, the chassis positioning systems 432-1, 432-1 can include independent hydraulic lifts that can independently move a corresponding chassis 410-1, 410-2 and/or fenders 440-1, 440-2 away from a ground surface to lower the bed 408 closer to the ground surface. In these embodiments, the chassis positioning systems 432-1, 432-1 can be coupled to a corresponding fender 440-1, 440-2 to move the corresponding independent chassis 410-1, 410-2. In this way, the components of the chassis 410-1, 410-2 can be moved relative to the bed 408 of the platform 404 to allow the bed 408 of the platform to be raised and lowered.

In some embodiments, the platform 404 can include a plurality of recesses 428 that can be configured to receive a corresponding plurality of keels that are positioned on a bottom portion 406 (e.g., first bottom portion 106-1, second bottom portion 106-2, etc.) of the enclosed structure 402. The plurality of recesses 428 can help guide the enclosed structure 402 to a correct or properly aligned location on the bed 408 of the platform 404. For example, the plurality of keels of the enclosed structure 402 can be aligned with the plurality of recesses 428. In this example, once the plurality of keels are within the corresponding plurality of recesses 428, the enclosed structure 402 can remain aligned as it is towed toward the split portion 418 (e.g., split portion 118 as referenced in FIG. 1, etc.).

Without the plurality of recesses 428, the enclosed structure 402 could move closer to one of the fenders 440-1, 440-2 and be away from a center line of the platform 404, which can cause the weight distribution to be off of the center line. This type of misalignment of the enclosed structure 402 on the platform 404 can cause significant problems when towing the platform 404 with the enclosed structure 402 utilizing a motorized vehicle, especially at high speeds. In addition, this misalignment can cause the enclosed structure 402 to potentially damage one or more of the chassis 410-1, 410-2, fenders 440-1, 440-2, and/or the chassis positioning systems 432-1, 432-2. That is, the plurality of recesses 428 with the corresponding keels on the bottom portion 406 of the enclosed structure 402 can create an easier and safer mechanism for loading and transporting the enclosed structure 402 compared to previous methods.

In some embodiments, the platform 404 includes a winch 426 (e.g., winch 326 as referenced in FIG. 3, etc.). The winch 426 can be a mechanical device that can be coupled to a frame of the platform 404. The winch 426 can include a tow strap 438 (e.g., tow rope, tow chain, etc.) that can be attached to the tow ring 446 of the enclosed structure 402. The winch 426 can include a drum or spool to wrap the tow strap 438 in order to pull the enclosed structure 402 onto the bed 408 of the platform 404. The winch 426 can provide the mechanical advantage needed to overcome the weight and friction of the enclosed structure 402, making it easier and safer to load the enclosed structure 402 onto the platform 404, even in wet or uneven conditions.

As described herein, the platform 404 can include a split portion 418 that is connected to a hinge 430. When the enclosed structure 402 is at a locking location (e.g., location where the locking mechanism of the enclosed structure 402 is aligned with a locking aperture of the plurality of recesses 428 of the platform 404, etc.), the split portion 418 can be raised to meet the raised or toboggan shaped portion of the front of the enclosed structure 402. This can allow air to be directed below the platform 404 during travel at high speeds and prevent air or debris from hitting the bottom portion 406 of the enclosed structure 402. That is, the air will be directed below the platform 404 or to the edges of the platform 404 by a bottom side of the split portion 418 instead of hitting the bottom portion 406 of the enclosed structure 402. Air or debris hitting the bottom portion 406 of the enclosed structure 402 can create additional pressure on the enclosed structure 402 and/or cause the platform 404 to move sporadically due to air being caught by the bottom portion 406 of the enclosed structure 402 during travel (e.g., driving down a highway, driving at high speeds, etc.).

Once the enclosed structure 402 is loaded on the bed 408 of the platform 404, the chassis positioning systems 432-1, 432-2 can be utilized to adjust the chassis 410-1, 410-2 such that the wheels are contacting the ground surface, the bed 408 is raised a desired distance from the ground surface, and the platform 404 is ready to be hauled by a motorized vehicle utilizing the hitch 424.

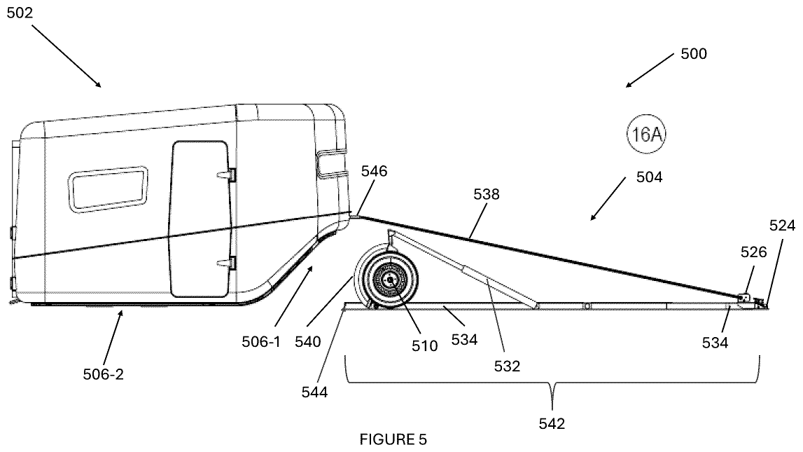

FIG. 5 illustrates a system 500 for a portable housing structure according to aspects of the present disclosure. In some embodiments, the system 500 is a side view of system 400 as referenced in FIG. 4 and includes the same or similar elements as system 100 as referenced in FIG. 1. The system 500 can illustrate one example of loading the enclosed structure 502 (e.g., enclosed structure 102 as referenced in FIG. 1, etc.) onto a bed of the platform 504 (e.g., platform 104 as referenced in FIG. 1, etc.). As described herein, the enclosed structure 502 can include a tow ring 546 (e.g., first tow ring 146-1 as referenced in FIG. 1, etc.). In these embodiments, the tow ring 546 can be utilized to load the enclosed structure 502 onto the bed of the platform 504.

In some embodiments, the platform 504 can be lowered utilizing the chassis positioning system 532 to alter a location of the chassis 510 and/or fenders 540 to lower the bed and/or frame 534 of the platform 504 to the ground to allow the enclosed structure 502 to slide on to the bed of the platform 504. As described herein, the chassis positioning systems 532 can include independent hydraulic lifts that can independently move a corresponding chassis 510 and/or fender 540 away from a ground surface to lower the frame 534 closer to the ground surface. In these embodiments, the chassis positioning systems 532 can be coupled to a corresponding fender 540 and a portion of the frame 534 to move the corresponding independent chassis 510. In this way, the components of the chassis 510 can be moved relative to the bed of the platform 504 to allow the bed and/or frame 534 of the platform to be raised and lowered. As illustrated in FIG. 5, the platform 504 can be lowered by the chassis positioning systems 532 such that a loading end 544 of the platform 504 can be flush (e.g., substantially the same level or height, etc.) with a ground surface. In some embodiments, the loading end 544 can be a lip portion or ramped portion of the platform 504 to prevent damage to the rear of the platform 504 when loading equipment such as, but not limited to, the enclosed structure 502.

In some embodiments, the loading end 544 can be made of a relatively harder material than the rest of the bed of the platform 504. For example, the loading end 544 can be made of a metal material while the bed of the platform 504 is made of a wood material. In other embodiments, the loading end 544 can be made of a relatively thinner material than the rest of the bed of the platform to allow the loading end 544 of the platform 504 to be more flush with the ground surface when the chassis positioning systems 532 lowers the bed of the platform 504 to the ground surface. In some embodiments, the loading end 544 can be part of the frame 534 of the platform 504. That is, the frame 534 of the platform 504 can be modified to a point or ramp shape at the end of the platform 504 to allow equipment to be loaded onto the bed of the platform 504.

In some embodiments, the chassis positioning systems 532 can lower the platform 504 such that the entire length 542 of the platform 504 or frame 534 of the platform 504 is parallel or substantially parallel with the ground surface. In some embodiments, the entire length 542 of the bottom surface of the frame 534 of the platform 504 can be in contact or substantial contact with the ground surface. For example, the hitch 524 can be positioned on a ground surface and the loading end 544 can be positioned on the same ground surface. Although the ground surface may not be perfectly level or flat, the bottom surface of the platform 504 or the frame 534 of the platform 504 between the hitch 524 and the loading end 544 can be substantially straight and thus parallel with the ground surface when the chassis positioning systems 532 lowers the platform 504 to the ground surface. In some embodiments, the entire length 542 of the bottom surface of the platform 504 and/or frame 534 of the platform 504 can be in contact with a ground surface when the ground surface is flat and level. Although not illustrated, a jack can be utilized to raise or lower the hitch 524 to a desired height that is independent of the height established by the chassis positioning systems 532 and/or suspension of the chassis 510.

As described herein, the platform 504 can include a plurality of recesses that can be configured to receive a corresponding plurality of keels that are positioned on a first bottom portion 506-1 and/or a second bottom portion 506-2 of the enclosed structure 502. The plurality of recesses can help guide the enclosed structure 502 to a correct or properly aligned location on the bed of the platform 504. For example, the plurality of keels of the enclosed structure 502 can be aligned with the plurality of recesses. In this example, once the plurality of keels are within the corresponding plurality of recesses, the enclosed structure 502 can remain aligned as it is towed toward the split portion (e.g., split portion 118 as referenced in FIG. 1, etc.).

In some embodiments, the platform 504 includes a winch 526 (e.g., winch 326 as referenced in FIG. 3, etc.). The winch 526 can be a mechanical device that can be coupled to a frame 534 of the platform 504. The winch 526 can include a tow strap 538 (e.g., tow rope, tow chain, etc.) that can be attached to the tow ring 546 of the enclosed structure 502. The winch 526 can include a drum or spool to wrap the tow strap 538 in order to pull the enclosed structure 502 onto the bed of the platform 504. The winch 526 can provide the mechanical advantage needed to overcome the weight and friction of the enclosed structure 502, making it easier and safer to load the enclosed structure 502 onto the platform 504, even in wet or uneven conditions.

Once the enclosed structure 502 is loaded on the bed of the platform 504, the chassis positioning systems 532 can be utilized to adjust the chassis 510 such that the wheels are contacting the ground surface, the bed is raised a desired distance from the ground surface, and the platform 504 is ready to be hauled by a motorized vehicle utilizing the hitch 524.

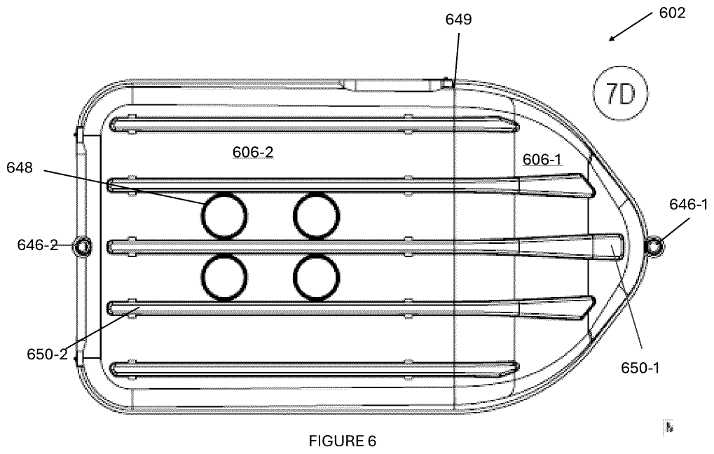

FIG. 6 illustrates a bottom side of an enclosed structure 602 of a system for a portable housing structure according to aspects of the present disclosure. The enclosed structure 602 can include the same or similar elements as enclosed structure 102 as referenced in FIG. 1. For example, the enclosed structure 602 can include a first tow ring 646-1 and a second tow ring 646-2. As described herein, the enclosed structure 602 can include a first bottom portion 606-1 and a second bottom portion 606-2.

The first bottom portion 606-1 can include a toboggan shaped portion of the enclosed structure 602. For example, the first bottom portion 606-1 can have a shape or a section with a smooth, curved design that mimics the contours of a traditional toboggan sled. This shape typically features a rounded or gently sloped front that transitions seamlessly into a flat or slightly concave base, designed to facilitate movement or minimize resistance. The curvature of the toboggan shaped portion allows for better aerodynamics and improved maneuverability, especially in environments where the enclosure may encounter wind, snow, or other external forces. In some embodiments, the first bottom portion 606-1 can have this toboggan shape to reduce drag when being towed, improve stability, and provide a visually appealing, streamlined design. The toboggan-inspired geometry also allows for smoother transitions when sliding or moving the enclosure over uneven or soft surfaces, such as snow, ice, or grass. This shape is often employed to optimize both functionality and aesthetics while ensuring ease of use in challenging conditions.

In some embodiments, the first bottom portion 606-1 can transition to the second bottom portion 606-2 at a transition point 649. The transition point 649 can be a location where the bottom surface makes contact with a flat surface (e.g., bed of the platform, ground surface, etc.). In this way, the first bottom portion 606-1 can be a raised point of the enclosed structure 602 that gradually lowers to the ground surface until it makes contact with the ground surface at the transition point 649. Although the second bottom portion 606-2 is a raised portion of the enclosed structure 602, it can still make contact with snow, mud, or other objects as the enclosed structure 602 is pulled along the ground surface.

As described herein, the first bottom portion 606-1 and second bottom portion 606-2 can include a first set of keels 650-1 coupled to the first bottom portion 606-1 and a second set of keels 650-2 coupled to the second bottom portion 606-2. In some examples, the first set of keels 650-1 and the second set of keels 650-2 are referred to as keels 650. That is, in some embodiments, the first set of keels 650-1 and the second set of keels 650-2 can be continuous keels 650 that extend from the first bottom portion 606-1 to the second bottom portion 606-2.

In some embodiments the keels 650 can include keel covers. As used herein, keel covers refer to protective accessories attached to the keels or skis of the enclosed structure 602 to enhance durability, reduce wear, and improve mobility over various surfaces. These covers are typically made from tough, wear-resistant materials such as high-density polyethylene (HDPE), rubber, or metal, designed to withstand abrasion and impact during transport or movement over ice, snow, gravel, or rough terrain. When installed on the keels 650, the covers create a smooth, low-friction surface that minimizes drag and prevents the underlying structure from being damaged or worn down. In addition to protecting the base of the enclosed structure 602, keel covers also improve ease of towing by reducing resistance and allowing the structure to glide more efficiently. Some covers are designed with replaceable segments or modular designs, enabling easy maintenance and extending the overall lifespan of the fish house. They are especially beneficial in preserving the integrity of the keels 650, ensuring consistent performance and reducing the need for frequent repairs or replacements.

In some embodiments, the size and/or shape of the first set of keels 650-1 can be different than the size and/or shape of the second set of keels 650-2. For example, the first set of keels 650-1 can be relatively wider and/or have a greater surface area compared to the second set of keels 650-2. In this way, the keels 650 can have an improved weight distribution, enhanced stability, reduced drag and resistance, improved maneuverability, and/or durability compared to having uniform keels that extend from the front to the back of the enclosed structure 602. In some embodiments, the first set of keels 650-1 can be tapered keels. As used herein, a tapered keel refers to a keel or ski that is wider on one end than the other and/or a keel that is wide at a front end and gradually narrows as it extends to the other end. In some embodiments, the first set of keels 650-1 can gradually narrow to the transition point 649. In some embodiments, the second set of keels 650-2 can be straight keels or keels that do not include a tapered end. In this way, the second set of keels 650-2 can be utilized to align with corresponding straight recesses within a platform bed.

As described further herein, having the different sized and/or shaped first set of keels 650-1 can result in having a corresponding differently sized and/or shaped recesses within a platform. For example, the recesses (e.g., plurality of recesses 328 as referenced in FIG. 3, etc.) can have a first size and shape within the bed (e.g., bed 308 as referenced in FIG. 3) and a second size and shape within the split portion (e.g., split portion 318 as referenced in FIG. 3). In this way, the second size and shape of the split portion can accommodate the first set of keels 650-1 of the first bottom portion 606-1 when the split portion of the platform is raised to meet the first bottom portion 606-1. Furthermore, since the first bottom portion 606-1 is a raised portion compared to the second bottom portion 606-2, the first set of keels 650-1 will not interact with the recesses of the bed when the enclosed structure 602 is loaded onto the platform.

In some embodiments, the enclosed structure 602 can include a plurality of apertures 648 located within the second bottom portion 606-2 of the enclosed structure 602. These apertures can include caps or lids that can be removed to allow access to the exterior area of the enclosed structure 602. In some embodiments, the plurality of apertures 648 can be utilized to access an area of ice for ice fishing. That is, a plurality of corresponding holes can be drilled into the ice to provide access to the water below the ice. The plurality of apertures 648 can be positioned over the holes in the ice to allow a user within the enclosed structure 602 to fish through the plurality of apertures 648. Although ice fishing through the plurality of apertures 648 is one use case, the plurality of apertures 648 can be utilized for a plurality of other purposes that require access to an exterior area of the enclosed structure 602.

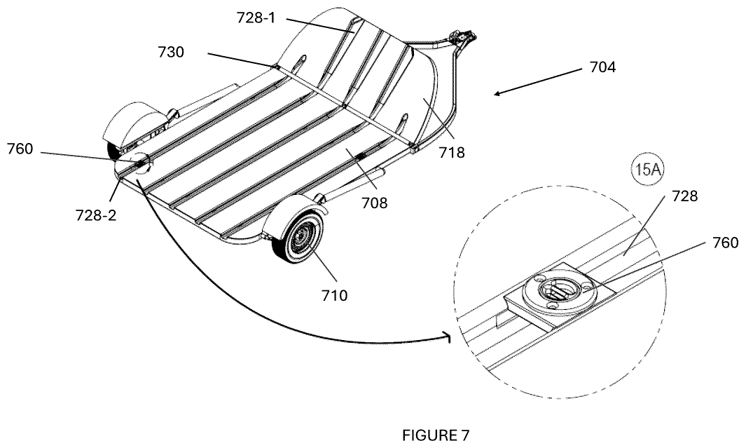

FIG. 7 illustrates a platform 704 portion of a system for a portable housing structure according to aspects of the present disclosure. Platform 704 can include the same or similar elements as platform 104 as referenced in FIG. 1. For example, the platform 704 can include a chassis 710 coupled to a bed 708 and a hinge 730 coupled to a split portion 718.

In some embodiments, the split portion 718 can include a first plurality of recesses 728-1 and the bed 708 can include a second plurality of recesses 728-2. In these embodiments, the first plurality of recesses 728-1 can correspond to a first size and shape of a first plurality of keels coupled to a first bottom portion of an enclosed structure enclosed (e.g., enclosed structure 102, etc.). In a similar way, second plurality of recesses 728-2 can correspond to a second size and shape of a second plurality of keels coupled to a second bottom portion of the enclosed structure. In one example, the first plurality of recesses 728-1 can be a tapered shape such that a tapered keel of the first plurality of keels can be positioned within the first plurality of recesses 728-1. In a similar way, the second plurality of recesses 728-2 can be a straight shape recess such that a straight keel of the second plurality of keels can be positioned within the second plurality of recesses 728-2.

In some embodiments, the first plurality of recesses 728-1 and/or the second plurality of recesses 728-2 can include one or more tie downs 760 (e.g., integrated tie-down connections, etc.). As used herein, the one or more tie downs 760 can refer to a device that secured to a location within one or more of the first plurality of recesses 728-1 or second plurality of recesses 728-2 to allow cargo or equipment to be secured to the platform 704. In some embodiments, the one or more tie downs 760 can be anchor point tie downs with a securing surface and a ring to allow for ropes or straps to be securely tied to the platform 704. In some embodiments, a top surface of the one or more tie downs 760 can be flush or substantially level with the bed 708 to allow the bed 708 to maintain a substantially flat surface. That is, the one or more tie downs 760 can be positioned within the first plurality of recesses 728-1 and/or second plurality of recesses 728-2 to ensure that the top of the 760 does not extend beyond the interior of the first plurality of recesses 728-1 or second plurality of recesses 728-2.

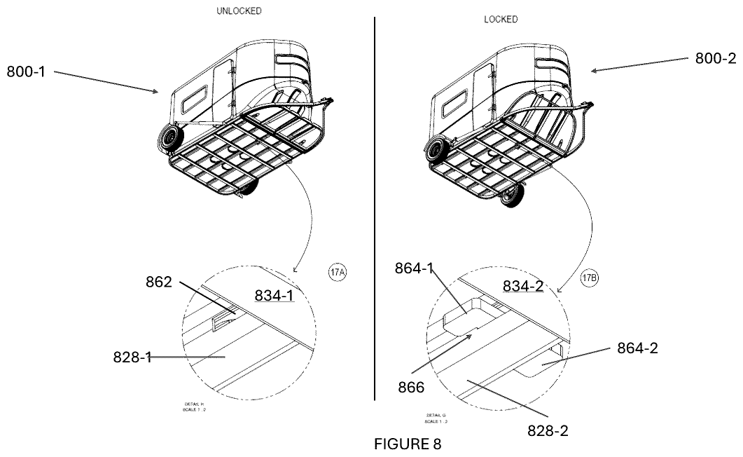

FIG. 8 illustrates the bottom side of a system 800-1, 800-2 for a portable housing structure according to aspects of the present disclosure. The system 800-1 illustrates the bottom of an unlocked state and the system 800-2 illustrates the bottom of a locked state. The systems 800-1, 800-2 can include the same or similar elements as system 100 as referenced in FIG. 1. For example, the systems 800-1, 800-2 can include an enclosed structure coupled to a platform. As described herein, the enclosed structure can be loaded and unloaded on the platform. In this way, the system 800-1 can illustrate when the enclosed structure can be unloaded from the platform and the system 800-2 can illustrate when the enclosed structure can be safely transported utilizing the platform.

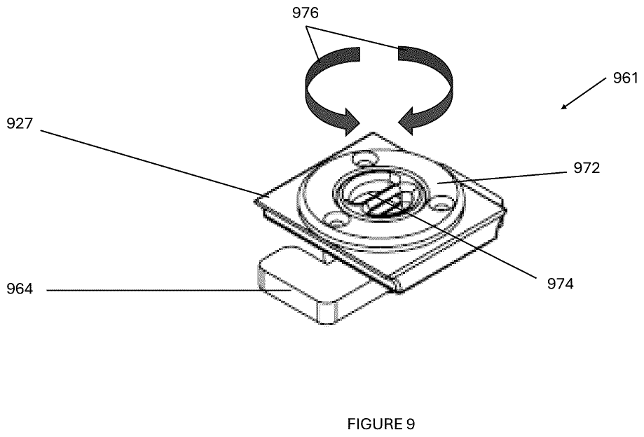

The system 800-1 can illustrate that the frame 834-1 can include recessed portions 828-1. In some embodiments, the recessed portions 828-1 can include a locking aperture 862. The locking aperture 862 can be located at a locking location of the platform. For example, when the enclosed structure is positioned at the locking location of the platform, the locking aperture 862 can be aligned with a locking tab 846-1 of a locking mechanism (e.g., locking mechanism 961 as referenced in FIG. 9, etc.). When the system 800-1 is in the unlocked position, the locking tab 846-1 can be positioned within the recessed portion 828-1 and is allowed to slide past the locking aperture 862.

The system 800-2 illustrates that the locking mechanism can be rotated or altered to position the locking tabs 846-1, 846-2 through corresponding locking apertures. When the locking tabs 846-1, 846-2 are positioned through the corresponding locking apertures, the recessed portion 828-2 of the frame 834-2 can prevent the enclosed structure from moving toward a rear portion of the platform. In some embodiments, the locking tabs 846-1, 846-2 can be “L” shaped such that a portion of the locking tab 864-1 extends over a portion 866 of the recessed portion 828-2. In this way, the locking tabs 846-1, 846-2 can prevent side to side movement of the enclosed structure along with the movement toward the rear of the platform.

FIG. 9 illustrates a locking mechanism 961 for a system for a portable housing structure according to aspects of the present disclosure. In some embodiments, the locking mechanism 961 (e.g., cam lock device, cam locking system, etc.) can be utilized to further secure the enclosed structure (e.g., enclosed structure 102 to a platform 104 as referenced in FIG. 1, etc.). In some embodiments, the locking mechanism 961 can include a plate 972 that can secure the locking mechanism 961 to an interior surface 927 of the enclosed structure. In this way, the locking mechanism 961 can be accessible to a user within the interior portion of the enclosed structure.

In some embodiments, the locking mechanism 961 can be a cam lock that is integrated into the floor of the enclosed structure in a cam mechanism, which locks the enclosed structure onto the platform in tandem with the locking track system. A person may turn the cam mechanism from inside the enclosed structure to lock and unlock the structure from the platform. In one embodiment, attached to the cam lock (rotatable portion 974) is a tongue (locking tabs 964), which is in line with the keels. Turning the cam locking mechanism turns the tongue, such that the tongue is perpendicular and sticking out of the sides of the keel.

In some embodiments, the interior surface 927 can be a floor area of the enclosed structure 102. In some embodiments, the floor area of the enclosed structure can include a plurality of individual locking mechanisms 961 distributed at different locations to ensure a secure connection between the bottom surface of the enclosed structure and the platform.

In some embodiments, the locking mechanism 961 can include a rotatable portion 974 to allow a user that has access to the rotatable portion 974 the ability to rotate the locking tabs 964 in the direction of arrows 976 (e.g., clockwise, counterclockwise, etc.). In this way, the rotatable portion 974 can allow a user to position the locking tabs 964 through corresponding locking apertures of the platform to lock the enclosed structure to the platform or position the locking tabs within the recesses of the platform to unlock the enclosed structure from the platform. As described further herein, the locking mechanism 961 can be positioned through a plurality of shells that are coupled together to form the enclosed structure.

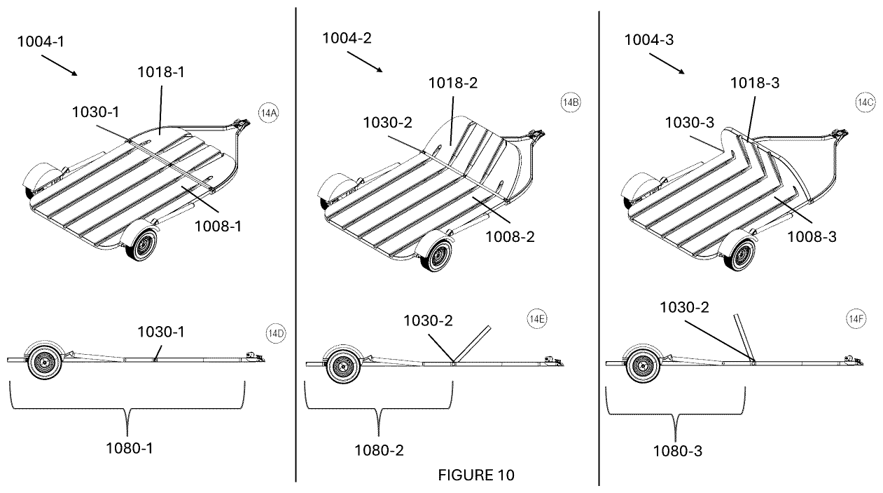

FIG. 10 illustrates a platform 1004-1, 1004-2, 1004-3 portion of a system for a portable housing structure according to aspects of the present disclosure. The platform 1004-1, 1004-2, 1004-3 can illustrate different positions of the split portion 1018-1, 1018-2, 1018-3 that can allow the platform 1004-1, 1004-2, 1004-3 to be utilized as a plurality of different trailers. The platform 1004-1, 1004-2, 1004-3 can include the same or similar elements as platform 104 referenced in FIG. 1. For example, the platform 1004-1, 1004-2, 1004-3 can include a corresponding bed 1008-1, 1008-2, 1008-3, corresponding hinge 1030-1, 1030-2, 1030-3 and a corresponding split portion 1018-1, 1018-2, 1018-3. Below each of the platforms 1004-1, 1004-2, 1004-3 is a side view of the corresponding platform 1004-1, 1004-2, 1004-3 that illustrates a corresponding useable distance 1080-1, 1080-2, 1080-3.

As described herein, the platform 1004-1, 1004-2, 1004-3 consists of a substantially flat surface, drop wheels in the rear portion of the platform 1004-1, 1004-2, 1004-3, and a hitch in the front portion of the platform 1004-1, 1004-2, 1004-3. The platform 1004-1, 1004-2, 1004-3 is relatively similar in shape and function to an otherwise normal flatbed utility trailer, with some additional features that augment the overall functionality of the platform 1004-1, 1004-2, 1004-3. The platform 1004-1, 1004-2, 1004-3 is designed so that it works in tandem with the enclosed structure to perform a variety of useful actions.

Integrated into the flat surface of the platform 1004-1, 1004-2, 1004-3 is a locking track system (e.g., plurality of recesses 428 as referenced in FIG. 4, first plurality of recesses 728-1 and second plurality of recesses 728-2 as referenced in FIG. 7, etc.), which aligns and locks the enclosed structure into place on the platform 1004-1, 1004-2, 1004-3. Near the forward portion of the platform 1004-1, 1004-2, 1004-3, a winch (e.g., winch 426 as referenced in FIG. 4, etc.) is attached to the structure to allow objects and the enclosed structure to be easily pulled onto the platform 1004-1, 1004-2, 1004-3. The wheels on the platform 1004-1, 1004-2, 1004-3 can be drop wheels, which allow the platform 1004-1, 1004-2, 1004-3 to be lowered to the ground.

A hitch on the front portion of the platform 1004-1, 1004-2, 1004-3 allows the platform 1004-1, 1004-2, 1004-3 to be pulled or towed by a vehicle. A forward portion of the flat surface of the platform 1004-1, 1004-2, 1004-3 may take the form of a flap (e.g., split portion 118 as referenced in FIG. 1, etc.), which can be folded up to interface with the toboggan style upward curve of the enclosed structure. The split portion may also be folded down to extend the overall length of the flat surface of the platform 1004-1, 1004-2, 1004-3.

The platform 1004-1, 1004-2, 1004-3 may be made of a lightweight aluminum frame (e.g., frame 334 as referenced in FIG. 3, etc.), with the platform surface (e.g., bed 108 as referenced in FIG. 1, etc.) being made of a lightweight material such as plywood, aluminum sheets, or a similar material. The platform surface may also be thermoformed in a similar process as the shells of the enclosed structure. If the platform surface is thermoformed, the platform surface may be similarly layered with a middle-ribbed surface, and a substantially flat surface that would cover the ribbed surface, where the structural members of the aluminum frame may fit in between the ribbing on the platform surface.

In some embodiments, the platform 1004-1 can illustrate a flatbed orientation. For example, the platform 1004-1 can be an orientation where the split portion 1018-1 is rotated along the hinge 1030-1 such that a bottom portion of the split portion 1018-1 is in contact with a frame of the platform 1004-1. In some embodiments, the split portion 1018-1 can be in-line with the base 1008-1 to allow the base 1008-1 to be used with the split portion 1018-1. In these embodiments, the usable distance 1080-1 can extend from a front edge of the split portion 1018-1. In some embodiments, the flatbed orientation can allow the platform 1004-1 to be useable as a conventional flatbed trailer.

In some embodiments, the platform 1004-2 can illustrate an enclosure structure orientation. For example, the platform 1004-2 can illustrate when the split portion 1018-2 rotates along the hinge 1030-2 to a position that aligns with a toboggan shaped bottom portion of an enclosed structure (e.g., first bottom portion 106-1 of the enclosed structure 102 as referenced in FIG. 1, etc.). As illustrated in the side view, the usable space 1080-2 can be relatively smaller than the corresponding useable distance 1080-1 from platform 1004-1. In some embodiments, the enclosure structure orientation can include an orientation when the split portion 1018-2 is at an obtuse angle (e.g., angle greater than 90 degrees, etc.) relative to the base 1008-2 or frame of the rest of the platform 1004-2.

In some embodiments, the platform 1004-3 can illustrate a utility orientation. For example, the platform 1004-3 can illustrate when the split portion 1018-3 is rotated along the hinge 1030-3 such that a portion of the split portion 1018-3 is positioned over a portion of the base 1008-3. As illustrated in the side view, the useable space 1080-3 can be relatively smaller than the corresponding usable distance 1080-1 from platform 1004-1. In some embodiments, the utility orientation can include an orientation when the split portion 1018-3 is at an acute angle (e.g., angle less than 90 degrees, etc.) relative to the base 1008-3 or frame of the rest of the platform 1004-3. In these embodiments, the split portion 1018-3 can be utilized to deflect airflow and debris away from equipment that is positioned on the base 1008-3 during travel.

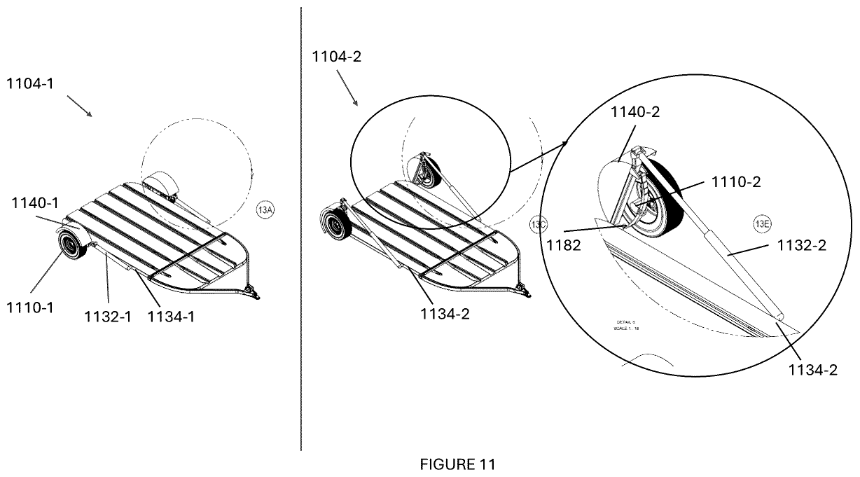

FIG. 11 illustrates a platform 1104-1, 1104-2 portion of a system for a portable housing structure according to aspects of the present disclosure. The platform 1104-1 can illustrate when the chassis positioning system 1132-1 is in a raised position and the platform 1104-2 can illustrate when the chassis positioning system 1132-2 is in a lowered position.

As described herein, the platform 1104-1 can be in a raised position or a position to allow the platform 1104-1 to be pulled by a motorized vehicle such that the wheels of the chassis 1110-1 contact the ground surface. As described herein, the chassis positioning system 1132-1 can be connected to the fender 1140-1 at a first side and connected to a frame 1134-1 at a second end. In this way, the chassis positioning system 1132-1 can adjust the position of the chassis 1110-1 such that the base of the platform 1104-1 is above a position of the chassis 1110-1 to allow the rear portion of the platform 1104-1 to be carried by the chassis 1110-1.

The platform 1104-2 can illustrate in more detail how the chassis positioning system 1132-2 can alter the position of the chassis 1110-2 from a lowered position as illustrated by platform 1104-1 to a raised position as illustrated by the platform 1104-2. In some embodiments, the chassis 1110-2 can be coupled to a frame 1134-2 at the first end and coupled to the chassis positioning system 1132-2 at a second end. In some embodiments, the first end of the chassis 1110-2 can be coupled to the frame 1134-2 by a rotating connection to allow the chassis 1110-2 to rotate when the chassis positioning system 1132-2 applies pressure on the second end of the chassis 1110-2. As illustrated by platform 1104-2, the chassis 1110-2 can include a suspension device 1182, a wheel, and a fender 1140-2 that can be raised above a bed and frame 1134-2 of the platform 1104-2.

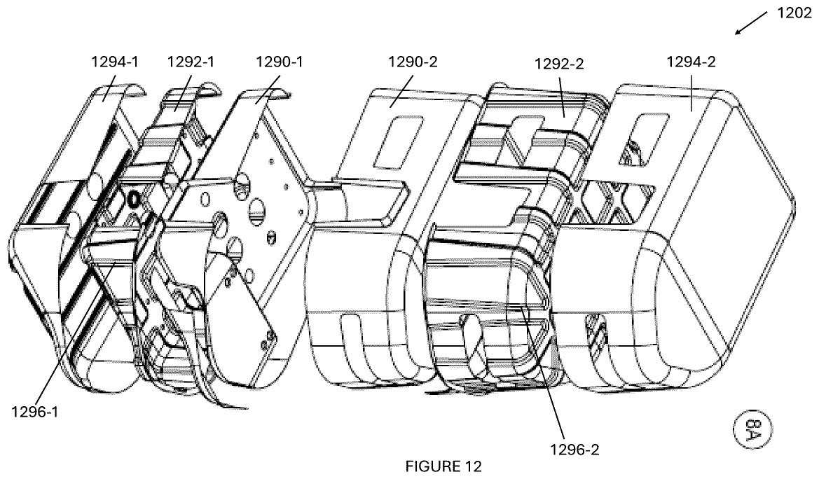

FIG. 12 illustrates an enclosed structure 1202 of a system for a portable housing structure with a plurality of nesting shells 1290, 1292, 1294 according to aspects of the present disclosure. In some embodiments, the plurality of nesting shells 1290, 1292, 1294 can each include multiple parts. For example, the interior nesting shell 1290 can include a first interior nesting shell 1290-1 and a second interior nesting shell 1290-2. In this example, the intermediate nesting shell 1292 can include a first intermediate nesting shell 1292-1 and a second intermediate nesting shell 1292-2. Furthermore, the exterior nesting shell 1294 can include a first exterior nesting shell 1294-1 and a second exterior nesting shell 1294-2.

In one embodiment, the enclosed structure 1202 can include a first shell (e.g., interior nesting shell 1290, etc.) coupled to the platform to define an interior of an enclosed area, a second shell (e.g., intermediate nesting shell 1292, etc.) coupled to the first shell to increase a rigidity of the first shell when coupled to the first shell, and a third shell (e.g., exterior nesting shell 1294) coupled to the second shell to protect the first shell and the second shell from external elements. In these embodiments, the intermediate nesting shell 1292 includes a ribbed surface (e.g., ribbed surfaces 1296-1, ribbed surfaces 1296-2, etc.) with pockets formed to facilitate additional structural components. For example, the additional structural components include one or more of insulation, electrical components, and hardware components. In some embodiments, the ribbed surfaces 1296-1, 1296-2 can create voids (e.g., spaces, etc.) between the intermediate nesting shell 1292 and the exterior nesting shell 1294. In addition, the ribbed surfaces 1296-1, 1296-2 can create voids between the intermediate nesting shell 1292 and the interior nesting shell 1290. In some embodiments, the voids are filled with a spray insulation material or foaming insulation material. As described herein, the voids can also be utilized to run electrical wiring for internal components and/or utilized to access external devices such as, but not limited to, generators, sewage systems, etc.

In some embodiments, the interior nesting shell 1290 can comprise a first interior nesting shell 1290-1 and a second interior nesting shell 1290-2. In some embodiments, the first interior nesting shell 1290-1 can be the bottom or floor portion of the interior nesting shell 1290 and the second interior nesting shell 1290-2 can be a top or roof portion of the interior nesting shell 1290. In some embodiments, the interior nesting shell 1290 can be a space that is utilized by a user to attach interior features such as, but not limited to: chairs, benches, beds, shelves, among other features of an interior of a housing structure. As described herein, the first interior nesting shell 1290-1 can be coupled to the second interior nesting shell 1290-2 to form the interior nesting shell 1290.

In some embodiments, the intermediate nesting shell 1292 can include the ribbed surfaces 1296-1 and/or the ribbed surfaces 1296-2. In addition to structural support, the ribbed surfaces 1296 (e.g., ribbing features, etc.) of the intermediate nesting shell 1292 provide a natural location for the routing of other components. If desired, support beams, electrical wiring, and other components could be slotted in between the ribbed surfaces 1296. Additional channels could also be integrally formed into the intermediate nesting shell 1292 for the routing of electrical wiring, and additional pockets could be formed into the intermediate nesting shell 1292 to hold specific hardware.

These channels and pockets make it extremely simple for a person to assemble the enclosed structure and allow for consistency in the manufacturing process. Hardware components that slot into pockets would be designed to perfectly nest into the intermediate nesting shell 1292, and electrical wiring would always be routed through the same locations across units. This consistency streamlines the manufacturing process, increasing efficiency and the overall quality of the finished assembly, while also ensuring that maintenance to the enclosed structure is similarly simple.

In some embodiments, the intermediate nesting shell 1292 can comprise a first intermediate nesting shell 1292-1 and a second intermediate nesting shell 1292-2. As described herein, the intermediate nesting shell 1292 can include a ribbed surfaces 1296-1, 1296-2. The ribbed surfaces 1296-1, 1296-2 can be utilized to create cavities. As described herein, the ribbed surfaces 1296-1, 1296-2 can be portions that extend from the intermediate nesting shell 1292 and an interior surface of the exterior shell 1294. In these embodiments, the spaces or cavities between the ribbed surfaces 1296-1, 1296-2 can be utilized to position a plurality of different components. For example, the spaces or cavities between the ribbed surfaces 1296-1, 1296-2 can be utilized to position insulation, electrical wiring, plumbing (e.g., gas, water, sewage, etc.), among other components between the interior nesting shell 1290 and the exterior shell 1294. In this way, the intermediate nesting shell 1292 can be utilized to position components based on a use of the enclosed structure 1202.

In some embodiments, the ribbed surfaces 1296-1, 1296-2 can increase the rigidity of the fully formed enclosed structure 1202. In some embodiments, the ribbed surfaces 1296-1, 1296-2 can act as support structures for the walls, floors, and ceiling of the enclosed structure 1202. In this way, the exterior nesting shell 1294 and/or the interior nesting shell 1290 can be less rigid or more flexible than the intermediate nesting shell 1292.

In some embodiments, the first interior nesting shell 1290-1 can be nested into and coupled to the first intermediate nesting shell 1292-1. In this example, the coupled first interior nesting shell 1290-1 and first intermediate nesting shell 1292-1 can be nested into and coupled to the first exterior nesting shell 1294-1. In a similar way, the second interior nesting shell 1290-2 can be nested into and coupled to the second intermediate nesting shell 1292-2. In this example, the coupled second interior nesting shell 1290-2 and second intermediate nesting shell 1292-2 can be nested and coupled to the second exterior nesting shell 1294-2.

In some embodiments, the exterior nesting shell 1294 can be an outermost shell of the enclosed structure, the exterior nesting shell 1294 can be one smooth, contiguous surface. The exterior nesting shell 1294 can protect the interior components from the outside elements, and the bottom of the exterior nesting shell 1294 is formed in a toboggan-like shape, allowing the enclosed structure to easily travel over snow, ice, and other surfaces.

In some embodiments, the first exterior nesting shell 1294-1 can include a plurality of keels formed into a bottom surface and in some embodiments the keels include keel covers. In some embodiments, the plurality of keels can be formed into the first exterior nesting shell 1294-1. For example, the plurality of keels can be formed and extend from the exterior side of the first exterior nesting shell 1294-1 to an interior side of the first exterior nesting shell 1294-1. In this way, the formed keels can be more rigid and less likely to fail compared to other devices that utilize attachment mechanisms (e.g., bracket, keel mount, etc.).

In some examples, the combined or coupled first exterior nesting shell 1294-1, first intermediate nesting shell 1292-1, and first interior nesting shell 1290-1 can be coupled to the combined or coupled second exterior nesting shell 1294-2, second intermediate nesting shell 1292-2, and second exterior nesting shell 1294-2 to form the enclosed structure 1202. In some embodiments, each shell of the plurality of nesting shells 1290, 1292, 1294 can be manufactured separately and when assembled or coupled, can be customized for a particular end use. For example, the interior nesting shell 1290 can be customized for a particular outdoor activity (e.g., ice fishing, hunting, etc.) while still utilizing the same or similar intermediate nesting shell 1292 and exterior nesting shell 1294. In some embodiments, the first exterior nesting shell 1294-1, first intermediate nesting shell 1292-1, first interior nesting shell 1290-1, second interior nesting shell 1290-2, second intermediate nesting shell 1292-2, and/or second exterior nesting shell 1294-2 can be independently manufactured and assembled after manufacturing for further customization of each nesting shell.

For example, the first interior nesting shell 1290-1 and the second interior nesting shell 1290-2 can be manufactured independently since the same second interior nesting shell 1290-2 could be utilized for both a hunting use or an ice fishing use while the first interior nesting shell 1290-1 may be customized differently for the hunting use or the ice fishing use. By allowing each of the plurality of nesting shells 1290, 1292, 1294 to be independently manufactured, a manufacturer can mass produce portions of the 1202 while customizing other portions for a specific use case.

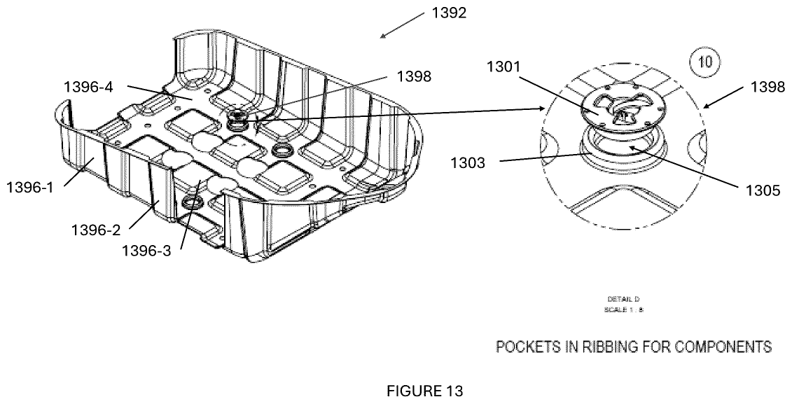

FIG. 13 illustrates an intermediate nesting shell 1392 of a plurality of nesting shells from an enclosed structure according to aspects of the present disclosure. As described herein, the nesting shell 1392 can be nested between an exterior nesting shell and an interior nesting shell. The intermediate nesting shell 1392 can include a plurality of ribbed structures 1396 such as, but not limited to a first ribbed structure 1396-1, a second ribbed structure 1396-2, a third ribbed structure 1396-3, and/or a fourth ribbed structure 1396-4. Although four ribbed structures are illustrated, additional or fewer ribbed structures can be utilized.

In some embodiments, the first ribbed structure 1396-1 can be a structure indented toward an interior of the intermediate nesting shell 1392. This type of structure can be utilized to position components or features between the intermediate nesting shell 1392 and an exterior nesting shell. For example, insulation can be positioned within the cavity formed by the first ribbed structure 1396-1.

In some embodiments, the second ribbed structure 1396-2 can be indented toward an exterior of the intermediate nesting shell 1392. In some embodiments, the second ribbed structure 1396-2 can be utilized to position components or features between the intermediate nesting shell 1392 and an interior nesting shell. In some embodiments, the second ribbed structure 1396-2 can be utilized as a cabinet storage that is accessible from the interior portion of the interior nesting shell. In other embodiments, the second ribbed structure 1396-2 can be utilized to position components that are accessible to a user within the interior nesting shell. For example, an electrical box can be positioned to a location that corresponds to the location of the second ribbed structure 1396-2.

In some embodiments, the third ribbed structure 1396-3 can be indented toward an interior of the intermediate nesting shell 1392. In some embodiments, the third ribbed structure 1396-3 can be positioned on a floor of the enclosed structure to allow components or features to be positioned between the 1392 and an exterior shell at a floor location. In a similar way, the fourth ribbed structure 1396-4 can be indented toward an exterior of the intermediate nesting shell 1392. In some embodiments, the fourth ribbed structure 1396-4 can be positioned on a floor of the enclosed structure to allow components or features to be positioned between the intermediate nesting shell 1392 and interior shell of the enclosed structure. In these embodiments, the interior shell can include access to the fourth ribbed structure 1396-4 to be accessible to the user.

In some embodiments, the intermediate nesting shell 1392 can include an access point 1398. The access point 1398 can include a cap 1301, an aperture 1305, and a ring 1303 to allow the access point 1398 to provide access to the intermediate nesting shell 1392, access to the exterior nesting shell, and/or access to an exterior portion of the enclosed structure. In some embodiments, the cap 1301 can include a threaded portion to thread onto the ring 1303 of the aperture 1305. In this way, a watertight, air tight, or sufficiently tight seal can be created for the aperture 1305 when not in use.

In some embodiments, the access point 1398 can be utilized to access the plurality of ribbed structures 1396 such that an end user can install different components and/or features without having to damage the enclosed structure or change a structural integrity of the enclosed structure. For example, the access point 1398 can be utilized to run electrical wires between the plurality of ribbed structures 1396 from a first location to a second location within the intermediate nesting shell 1392.

Thus, a user can access different shells of a plurality of nesting shells to allow for end user customization by enabling access to external components (e.g., generator, etc.), allowing access to the plurality of ribbed structures 1396, and/or providing cavities that can allow for housing elements such as, but not limited to cabinets, fuse boxes, or other features that require space behind the interior surface of an interior shell. Without the intermediate nesting shell 1392 a user may not be able to add electrical without causing damage to the existing product or running it in a way that may not be safe (e.g., external wiring that is not protected, drilling holes into spaces that were not intended for wiring, removing insulation to make space for the wiring, etc.).

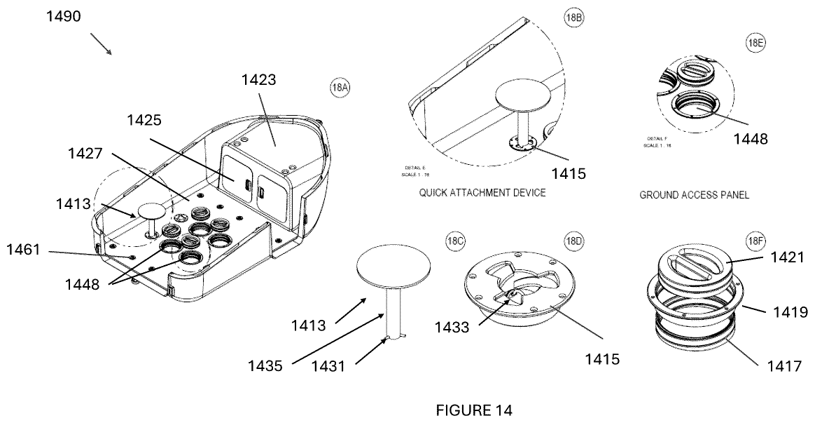

FIG. 14 illustrates an interior nesting shell 1490 of a plurality of nesting shells from enclosed structure according to aspects of the present disclosure. The interior nesting shell 1490 can illustrate a number of housing components or features that can be added or removed from the interior nesting shell 1490 utilizing quick attachment devices 1415 and/or ground access panels 1448.

As described herein, the interior nesting shell 1490 can be one smooth, contiguous surface. The interior nesting shell 1490 nests inside of the middle shell, and creates a flat surface for the floor 1427, walls, and roof of the enclosed structure while covering up electrical components, hardware components, insulation, etc. Other features may be integrally formed into the interior nesting shell 1490, such as shelving surfaces, benches, cabinets, etc. The interior nesting shell 1490 may be formed to create shelving, benches, cabinets, and other features. For example, the interior volume above the toboggan-like curve in the front portion of the enclosed structure might otherwise be an unusable space. By forming a shelf or storage area 1423 into the interior nesting shell 1490, this volume can be used as a surface to place objects.

Additionally, holes can be cut into the vertical surface of this shelf, to allow access to the volume between the interior nesting shell 1490 and the intermediate shell (e.g., intermediate nesting shell 1392), to create a cabinet for additional storage. Similar features can be formed into the interior nesting shell 1490 to create overhead cabinets, additional shelving, benches, and other integrally formed features. Where cabinets are created, additional paneling can be formed to block access to the intermediate shell from inside the storage volume. Different versions of the interior nesting shell 1490 may be created to allow the structure to be configured in different ways.

Additionally, access panels (ground access panels 1448) may be created that allow a person to access the ground outside of the enclosed structure. The ground access panels 1448 may be covered by a ground access panel cover (e.g., screw cap 1421), consisting of an internally threaded collar (floor ring 1419), which is fastened to the enclosed structure. A sleeve (interior ring 1417), which is threaded both internally and externally, would screw into the collar, and a plug, with external threads, would screw into the sleeve. The top surface of the plug would be flush with the floor surface of the enclosed structure, and the bottom surface of the plug would be flush with the bottom surface of the exterior shell. The plug would seal the access panel. When the plug is removed, the sleeve can be screwed further down into the collar, such that the bottom edge of the sleeve touches the ground, resealing the interior of the enclosed structure from the elements.

In some embodiments, the interior nesting shell 1490 can be part of a trailer assembly as described herein. In some embodiments, the interior nesting shell 1490 can include interior components (e.g., stool 1413, etc.) coupled to an interior portion of the interior nesting shell 1490 from the plurality of nesting shells. In these embodiments, quick attachment devices 1415 can be positioned at a plurality of locations of the interior portion of the interior nesting shell 1490 to couple accessories to the interior portion. As described further herein, ground access panels (e.g., ground access panels 1448) through the exterior shell to access an exterior portion of the removable enclosed structure. As described further herein, the ground access panels 1448 can include internally threaded collars (e.g., interior ring 1417, floor ring 1419, screw cap 1421, etc.).

In some embodiments, the interior nesting shell 1490 can include a storage area 1423 located within a toboggan shaped portion of the interior nesting shell 1490. As described herein, the toboggan shaped portion (e.g., first bottom portion 106-1 as referenced in FIG. 1, etc.) can be shaped to allow for easy transportation on keels. The toboggan shaped portion can create a non-flat surface at the front end of the interior nesting shell 1490. For this reason, a storage area 1423 can be utilized. Although a 1423 is illustrated, the same area of the 1490 could be designed for a bench, bed, or other structure without departing from the present disclosure.

In some embodiments, the storage area 1423 can include a number of doors 1425 to access an area within the storage area 1423. In some embodiments, the space within the 1423 may be further altered by the interior shell or intermediate shell as described herein. For example, the intermediate shell may include ribbed structures to provide additional cavities that are accessible within the storage area 1423. In some embodiments, the doors 1425 can be lockable to prevent access to the additional cavities associated with the intermediate shell. For example, a fuse box or other feature can be positioned within the storage area 1423.

In some embodiments, the interior nesting shell 1490 can include a locking mechanism 1461 (e.g., locking mechanism 961 as referenced in FIG. 9, etc.). As described herein, the locking mechanism 1461 can be accessible within the interior nesting shell 1490 such that a user within the interior nesting shell 1490 can lock and unlock the enclosed structure from the platform. As described herein, the interior nesting shell 1490 can include a floor 1427 that can be strong enough for a human user to stand on and/or strong enough to be utilized as a covered trailer.

In some embodiments, the floor 1427 can include ground access panels 1448. The ground access panels 1448 can be utilized to access the exterior portion of the enclosed structure. For example, the ground access panels 1448 can be utilized as ice fishing holes when the interior nesting shell 1490 is configured for ice fishing. In other embodiments, the ground access panels 1448 can be utilized for other purposes.

In some embodiments, the interior nesting shell 1490 can include quick attachment devices 1415 that are coupled to the floor 1427. The quick attachment devices 1415 can be devices that can be flush with the floor 1427 of the interior nesting shell 1490 such that a top of the quick attachment devices 1415 is substantially level with the floor 1427. In some embodiments, the quick attachment devices 1415 can be utilized to connect a stool 1413 to the floor 1427. Although a stool 1413 is illustrated as a component that can be coupled to the quick attachment devices 1415 other components can be coupled to the same type of quick attachment devices 1415. For example, a table, a booth, a fishing stand, and/or other types of housing features or components can be coupled to the quick attachment devices 1415.

In some embodiments, the quick attachment devices 1415 includes a base that allows protruding fins 1431 of an attachment (e.g., stool 1413) to be locked within the quick attachment devices 1415. In some examples, the protruding fins 1431 can be inserted into corresponding tabs 1433. In these embodiments, the protruding fins 1431 can be inserted into the corresponding tabs 1433 and the attachment can be rotated in a first direction to lock the attachment to the quick attachment devices 1415 and rotated in a second direction to unlock the attachment from

The quick attachment devices 1415 is a novel system for the quick attachment and detachment of accessories such as tables or chairs. The quick attachment devices 1415 consists of a base with a recessed pocket (e.g., tabs 1433), where the pocket is covered by a plate with slots cut into it. The inside of the pocket is shaped such that there is a surface, running from a slot to the bottom of the pocket, which slopes downwards in a wedge-like shape. On accessories, there is a post 1435. Near the bottom of the post, protruding fins 1431 can protrude outwards, which fit into the corresponding tabs 1433 on the plate of the quick connect base 1415. To connect an accessory to the quick connect system, a post 1435 is inserted into the pocket (e.g., corresponding tabs 1433) on the base and twisted, such that that the protruding fins 1431 on the post 1435 slide along the sloped surface on the base. As the protruding fins 1431 reach the bottom of the sloped surface, they are tightly wedged into the base, locking the post 1435 in place. To remove an accessory, the above process is reversed.

The accessories that can be attached to the enclosed structure using the quick attachment devices 1415 differ from the integrally formed furniture features, such that the accessories can be attached, detached, and rearranged, whereas the integrally formed furniture, formed into the interior nesting shell 1490, is integral to the shells of the enclosed structure. However, the accessories and the integrally formed furniture features may be used in conjunction with each other. For example, a person may attach a chair accessory adjacent to an integrally formed shelf, allowing the person to sit in the chair while using the shelf as a table.

In some embodiments, the one or more tie downs 760 as referenced in FIG. 7 can be integrated with the quick attachment devices 1415. As described herein, the one or more tie downs 760, which allow a person to restrict the motion of objects inside the enclosed structure, may be attached and detached to the quick attachment devices 1415, using a similar method as described later herein. Instead of a post, the tie-down would consist of a small plate, with a recessed pocket, where the tie-down hook is located inside the pocket. The bottom of the tie-down accessory would have fins, similar to the protruding fins 1431 of the quick connect post 1435, which would slot into the quick connect base.

In some embodiments, the ground access panels 1448 can be sealed and unsealed utilizing an interior ring 1417, a floor ring 1419, and/or a screw cap 1421. In some embodiments, the interior ring 1417 can be coupled to one of the exterior nesting shell or the intermediate nesting shell. The floor ring 1419 can be coupled to the floor 1427 of the interior nesting shell 1490. The screw cap 1421 can be accessible from the interior of the interior nesting shell 1490. In another embodiment, the quick attachment devices 1415 may be designed such that a tie-down feature is designed integral to the quick attachment devices 1415 (e.g., quick connect base). In this embodiment, the tie-down is not an accessory which connects to the quick attachment devices 1415; instead, the tie-down is permanently connected to the quick connect base. In this embodiment, the tie-down feature, integral to the quick attachment devices 1415, does not interfere or otherwise block the attachment or detachment of additional accessories using the quick attachment devices 1415.

Other than the uses described above, the modular trailer can be useful in a variety of other scenarios due to its unique combination of features. For example, the modular trailer may be useful in certain construction settings. In harsh conditions, the enclosed structure may allow workers to access the ground beneath the structure, allowing them to access underground utilities and manholes in relative comfort. In this use, the workers would then also have access to the platform, which they can use as a flatbed trailer for the duration of their work.

Instead, they may use the enclosed structure as a storage shed for tools and materials, while using the platform as a flatbed trailer. In another example, it may be useful to use the modular trailer as a lightweight mobile and temporary office or workspace. For example, a construction manager might use the enclosed structure, with accessories attached inside, as a mobile and secure workspace, while the other works could continue to use the platform as a workspace or lightweight trailer.

In the foregoing detailed description of the disclosure, reference is made to the accompanying drawings that form a part hereof, and which are shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 302 in FIG. 3. Elements shown in the various figures herein can be added, exchanged, and/or eliminated to provide additional examples of the disclosure. In addition, the proportion and the relative scale of the elements provided in the figures are intended to illustrate the examples of the disclosure and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc. Further, as used herein, “a” refers to one such thing or more than one such thing.

What is claimed is:

1. An apparatus, comprising:
a platform;
an enclosed structure that is connected to the platform in a first mode and separated from the platform in a second mode, the enclosed structure comprising:
a first shell to define an interior of an enclosed area;
a second shell coupled to the first shell to increase a rigidity of the first shell when coupled to the first shell; and
a third shell coupled to the second shell to protect the first shell and the second shell from external elements.

2. The apparatus of claim 1, wherein the second shell includes a ribbed surface with pockets formed to facilitate additional structural components, wherein the additional structural components include one or more of insulation, electrical components, and hardware components.

3. The apparatus of claim 1, wherein the second shell includes a toboggan shaped structure that nests within the third shell that includes a corresponding toboggan shaped structure.

4. The apparatus of claim 3, wherein the third shell includes a plurality of keels formed into a bottom surface of the third shell and wherein the plurality of keels include keel covers.

5. The apparatus of claim 1, comprising support beams and electrical wiring positioned between a ribbed surface of the second shell and a surface of the third shell.

6. The apparatus of claim 1, wherein the first shell, the second shell, and the third shell are separate components that are manufactured separately.

7. The apparatus of claim 1, wherein the second shell includes a ribbed surface that creates voids between the second shell and the third shell and wherein the voids are filled with a spray insulation material.

8. A trailer assembly, comprising:
a removable enclosed structure comprising a plurality of nesting shells;
interior components coupled to an interior portion of a first shell of the plurality of nesting shells;
access panels through the first shell and a second shell to allow access to a third shell of the plurality of shells; and
quick attachment devices positioned at a plurality of locations of the interior portion of the first shell to couple accessories to the interior portion of the first shell, wherein the plurality of nesting shells are manufactured independently.

9. The trailer assembly of claim 8, comprising ground access panels through the third shell to access an exterior portion of the removable enclosed structure, wherein the ground access panels include internally threaded collars.

10. The trailer assembly of claim 8, wherein the quick attachment devices include a base that allows protruding fins of an attachment to be locked within the quick attachment devices.

11. The trailer assembly of claim 8, wherein the quick attachment devices include an integrated tie-down connection positioned between a recess of a bed of the trailer assembly.

12. The trailer assembly of claim 8, comprising towing hooks coupled to an exterior portion of the third shell.

13. The trailer assembly of claim 8, comprising a set of double doors at a first end of the first shell, the second shell, and the third shell to allow the trailer assembly to be utilized as a covered trailer.

14. The trailer assembly of claim 8, wherein the removable enclosed structure includes a cam lock device to couple the removeable enclosed structure to a platform structure from the interior portion of the first shell.

15. The trailer assembly of claim 8, comprising a platform structure that includes a hitch and an axle to allow the platform structure to be pulled as a trailer, wherein the platform structure includes a cam lock device to lock the removable enclosed structure to a surface of the platform structure.

16. The trailer assembly of claim 15, wherein the platform structure includes a locking track system of recesses to allow keels coupled to the third shell to be positioned within the locking track system.

17. A system, comprising:
a removable enclosed structure comprising a plurality of nesting shells that allow components to be positioned between the plurality of nesting shells, wherein one of the plurality of shells includes a cam lock device;
a platform structure comprising a chassis, a hitch, and a flatbed, wherein the platform structure comprises:
a locking track system that includes a plurality of recesses within the flatbed to receive keels coupled to the removable enclosed structure, wherein the cam lock device includes a locking tab that rotates to lock the removable enclosed structure utilizing the keels;
a plurality of adjustable tie downs moveable along a sliding mechanism coupled to an edge of the flatbed;
a winch device to move the removable enclosed structure from a first end of flatbed to a second end of the flatbed; and
a chassis positioning system to adjust a height of the flatbed.

18. The system of claim 17, wherein the chassis positioning system includes independent chassis for each wheel of the platform structure such that an axle does not extend below the flatbed.

19. The system of claim 17, wherein the chassis positioning system is a pivoting drop wheel assembly with a jack device fixed adjacent to the chassis positioning system.

20. The system of claim 17, comprising a split portion of the flatbed coupled by a hinge to allow the split portion to rotate around the hinge, wherein the split portion rotates to meet a surface of an exterior shell of the plurality of nesting shells.
